(19) United States
(12) Patent Application Publication
(10) Pub. No.: US 2010/0195241 A1
(43) Pub. Date: Aug. 5, 2010

(54) ZONE TEXTURED RECORDING HEAD

(76) Inventors: Matthew P. Dugas, St. Paul, MN (US); Gregory Lawrence Wagner, Arden Hills, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/695,871

(22) Filed: Jan. 28, 2010

Related U.S. Application Data
(60) Provisional application No. 61/147,935, filed on Jan. 28, 2009.

(51) Int. Cl. G11B 5/03; G11B 5/33; G11B 5/02

(52) U.S. Cl. 360/66; 428/810; 360/55; G9B/5.026

(57) ABSTRACT

The present disclosure relates to a magnetic recording head having a slider media bearing interface surface with surface modifications configured to reduce friction and/or stiction friction properties between the head slider media bearing interface surface and a recording medium. The present disclosure also relates to a tape drive system, a method of formatting a recording medium using such a magnetic recording head, and the resulting formatted media.

### CROSS REFERENCE TO RELATED APPLICATION

The present application claims priority to U.S. Provisional Patent Application No. 61/114,7935, filed on Jan. 28, 2009, and entitled Zone Textured Recording Head, the entire contents of which are hereby incorporated by reference herein in their entirety.

### FIELD OF THE INVENTION

The present disclosure relates generally to magnetic recording heads and more particularly to systems and methods for reducing the sticking, friction, static friction, and/or stiction forces at the interface between a magnetic recording head and a flexible magnetic recording media.

### BACKGROUND OF THE INVENTION

Future generations of flexible magnetic recording media will utilize smoother surfaces than are currently employed. This trend is a result of many factors, including a reduction in the spacing between the head and the media in order to reduce recording fidelity loss.

Increased smoothness in magnetic media reduces the head-to-media spacing but presents problems in other areas. When two smooth surfaces are proximate, or have intimate contact, a condition called “stiction” results. “Stiction” is a term describing complex interactions in the regime of sticking and friction resulting from various mechanical, chemical, electromagnetic, or fluid considerations. The result of this “stiction” is a tendency for the smooth surfaces to stick together.

Stiction can produce many unwanted behaviors in a magnetic recording system. These include, but are not limited to, an increase in the interface friction above what is desirable for mechanical stability and wear; a “stick-slip” phenomenon in which the media alternatively sticks and then slips; as well as an increase in the effective coefficient of static friction at the interface.

An increase in the effective coefficient of static friction can cause unwanted characteristics of the transducer-media interface. For example, when the medium is not moving, the adhesion of the medium to the head can cause start-up problems.

The stick-slip phenomenon also causes the relative velocity of the media-transducer interface to be non-uniform. This non-uniform velocity can lead to reduced recording system capability. As an example, Time Based Servo (TBS) recording operates by knowing the time between servo magnetic recording transitions. As the tape streams past the head, these transitions are detected by the magnetic transducer. The time between transitions is then used as the metric for a servo control. In particular, the time between transitions is used as a distance or length metric. In order for this condition to be true, the tape magnetic medium must be streaming at a constant, known velocity. Stick-slip conditions at the head-media interface can detrimentally affect this type of detection.

FIG. 1 illustrates one example of a traditional multi-channel thin film magnetic recording head slider body, including a tape bearing interface surface that is smooth or substantially smooth. The magnetic recording head includes transducer elements, which are responsible for reading and/or writing the magnetic transitions onto passing magnetic media. FIG. 2 illustrates an enlarged view of the top surface of the magnetic recording head of FIG. 1. As can be seen in FIGS. 1 and 2, traditional thin film magnetic recording heads include smooth, unmodified, or non-textured media interface surfaces. Some heads may include air bleed slots at the leading and trailing edges of the slider body to remove entrained air. While other heads may include some negative pressure slots to help adhere the medium to the head even more aggressively. However, the predominant large surface area of the slider body is by and large optically polished and optically smooth so that the tape medium is well behaved as it passes over the surface. With the advent of ultra-smooth flexible media, the smoothness of the head in combination with the smoothness of the smoother media presents stiction issues which need to be addressed.

Thus, there exists a need in the art for a means for reducing stiction in magnetic tape recording systems. Particularly, there exists a need in the art for magnetic recording heads that control and/or reduce the sticking, friction, static friction, and/or stiction forces at the interface between the magnetic recording head and the magnetic recording media.

### BRIEF SUMMARY OF THE INVENTION

The present disclosure, in one embodiment, relates to a magnetic recording head slider body whose slider media bearing interface surface has surface modifications configured to reduce friction and/or stiction friction properties across large portions of the head-to-tape interface and yet retains an otherwise unmodified optically smooth surface in the much smaller region surrounding the write and read thin film elements of the recording head.

The present disclosure, in another embodiment, relates to a magnetic recording head having a slider media bearing interface surface with surface modifications configured to reduce friction and/or stiction friction properties between the head slider media bearing interface surface and a recording medium.

The present disclosure, in a further embodiment, relates to a tape drive system having a head actuator assembly including a head slider body. The slider body includes a slider media bearing interface surface with surface modifications configured to reduce friction and/or stiction friction properties between the slider media bearing interface surface and a recording medium

The present disclosure, in yet another embodiment, relates to a magnetic recording media made by passing the magnetic recording media over a magnetic recording head having a media bearing interface surface with surface modifications configured to reduce friction and/or stiction friction properties at an interface formed between the media bearing interface surface and the magnetic recording media and energizing the magnetic recording head to cause a pattern of magnetic transitions to be written to the magnetic recording media.

The present disclosure, in another embodiment, relates to a method of formatting magnetic tape. The method includes providing a magnetic recording head having a media bearing interface surface with surface modifications configured to reduce friction and/or stiction friction properties at an interface formed between the media bearing interface surface and a recordable medium. A recordable medium is then passed over the media bearing interface surface to record to the medium.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 shows a perspective view of an example traditional thin film magnetic recording head.

FIG. 2 shows an enlarged top view of the magnetic recording head of FIG. 1.

FIG. 3a shows a close up, top view of a region of a media bearing interface surface which has regions in-between the read/write elements with surface texture modifications according to one embodiment of the present disclosure.

FIG. 3b shows a close up, top view of a region of a media bearing interface surface which has regions in-between the read/write elements with surface texture modifications according to another embodiment of the present disclosure.

FIG. 3c shows a cross-sectional, perspective view of one type of example surface modifications according to the present disclosure.

FIG. 3d shows a cross-sectional, perspective view of another type of example surface modifications according to the present disclosure.

FIG. 4a shows a perspective view of a surface texture modified magnetic head according to another embodiment of the present disclosure.

FIG. 4b shows a close up, top view of the surface texture modified magnetic head of FIG. 4a.

FIG. 4c shows a cross-sectional, perspective view of one type of example surface modifications according to the present disclosure for the surface texture modified magnetic head of FIG. 4a.

FIG. 5 shows a top view of a surface texture modified media bearing interface surface according to yet another embodiment of the present disclosure.

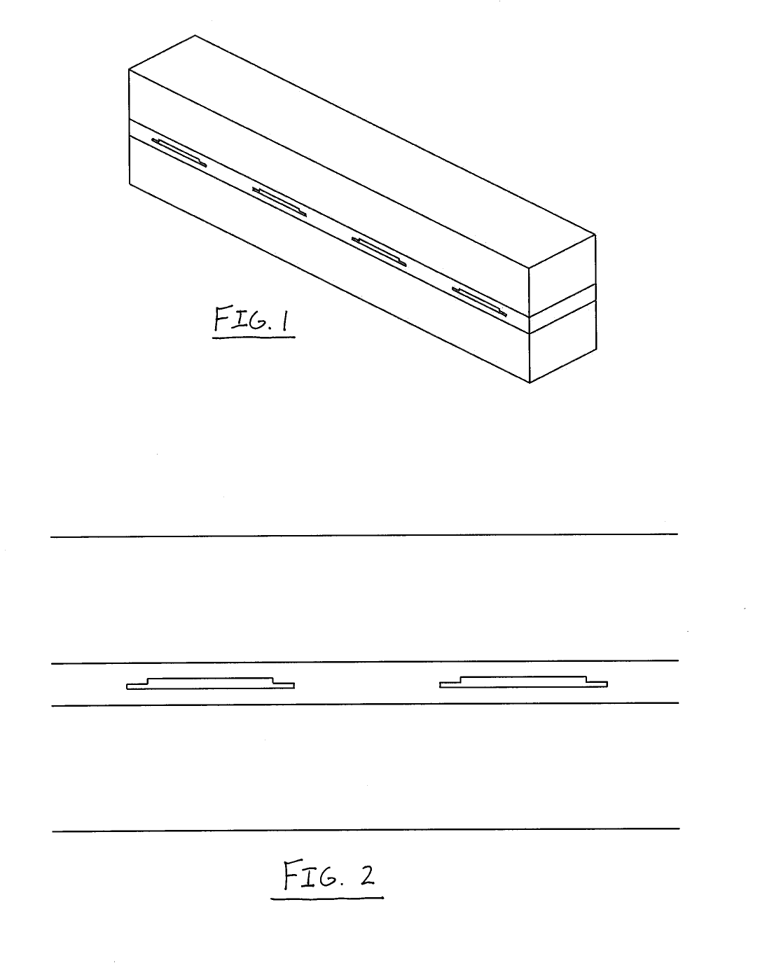

### DETAILED DESCRIPTION

The present disclosure relates to novel and advantageous modifications to the media interface surface or recording surface of the magnetic recording head (“head”) to control, minimize or eliminate stiction at the media bearing interface surface. Particularly, the present disclosure relates to reductions in the effective surface area of the magnetic head through use of textures, dimples, or other surface modifications, as will be described in further detail below. As used herein, the effective surface area may include the surface area of the head that is in contact or in close proximity to the surface of the magnetic tape as the tape passes by the media interface surface. The magnitude of the stiction forces is dependent upon the effective contact surface area and thus reducing the effective contact surface area of the head can reduce the frictional coefficients and stiction behavior.

In some embodiments, the head contains a media bearing interface surface or recording surface that contacts, or comes into close proximity with the recording media when the device is operational and recording or reading. The media bearing interface surface of the head may be flat or may be contoured. In one embodiment, the head may be a thin film magnetic recording head, including but not limited to a multi-channel thin film magnetic recording head. However, it is understood that the various embodiments of the present disclosure may apply to any type of magnetic recording head used in conjunction with a flexible recording media. The head contains one or more transducers for reading and/or writing information or data to the recording media. Whatever type of magnetic recording head is used, the slider media bearing interface surface can contain surface modifications configured to reduce friction and/or stiction friction properties. The surface modifications provide roughness to the media bearing interface surface.

In flexible media recoding, also called contract recording, the media or tape is said to fly over the head. Accordingly, the media bearing interface surface, also called the slider tape bearing surface, can be modified such that it retains its “flying” conditions while at the same time reducing the stiction between the surfaces. More particularly, for example, the surface may be modified to allow designed air entrainment and/or effective flying conditions of the media with respect to the tape interface. This may, for example, allow the head-media spacing to be tailored for better or optimal mechanical as well as better or optimal magnetic performance.

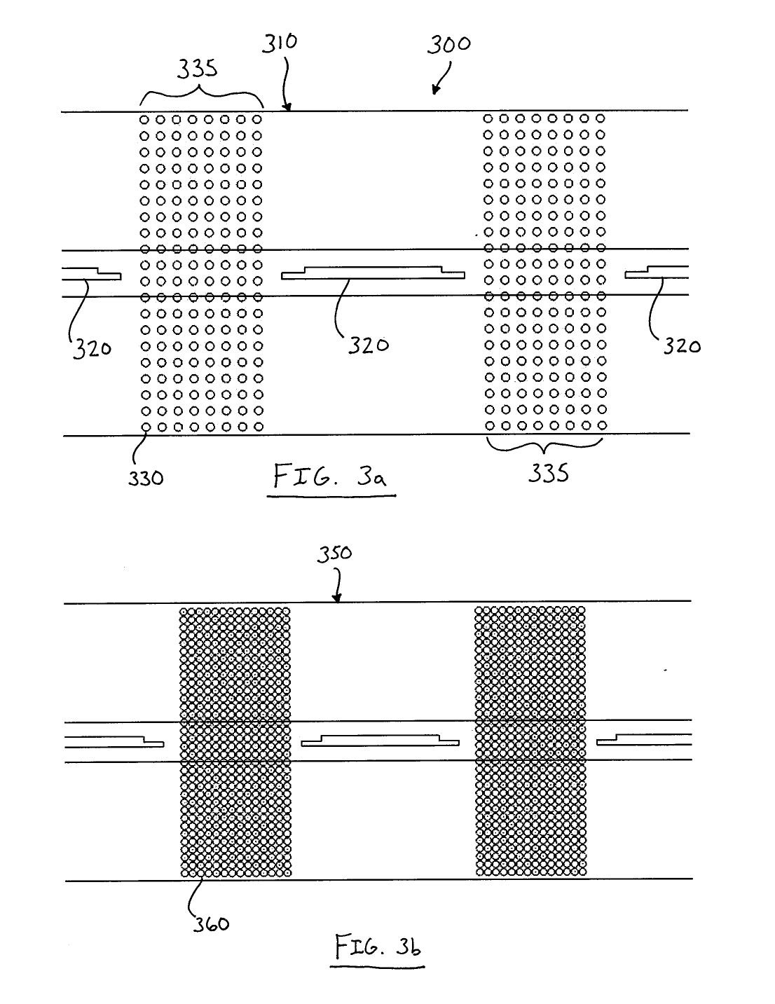

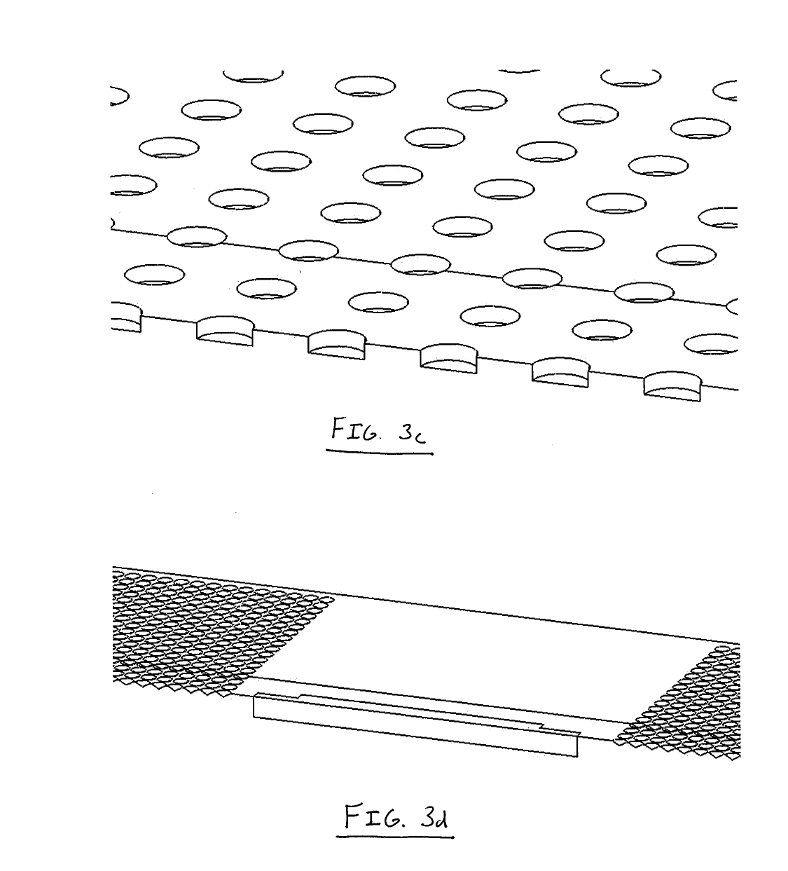

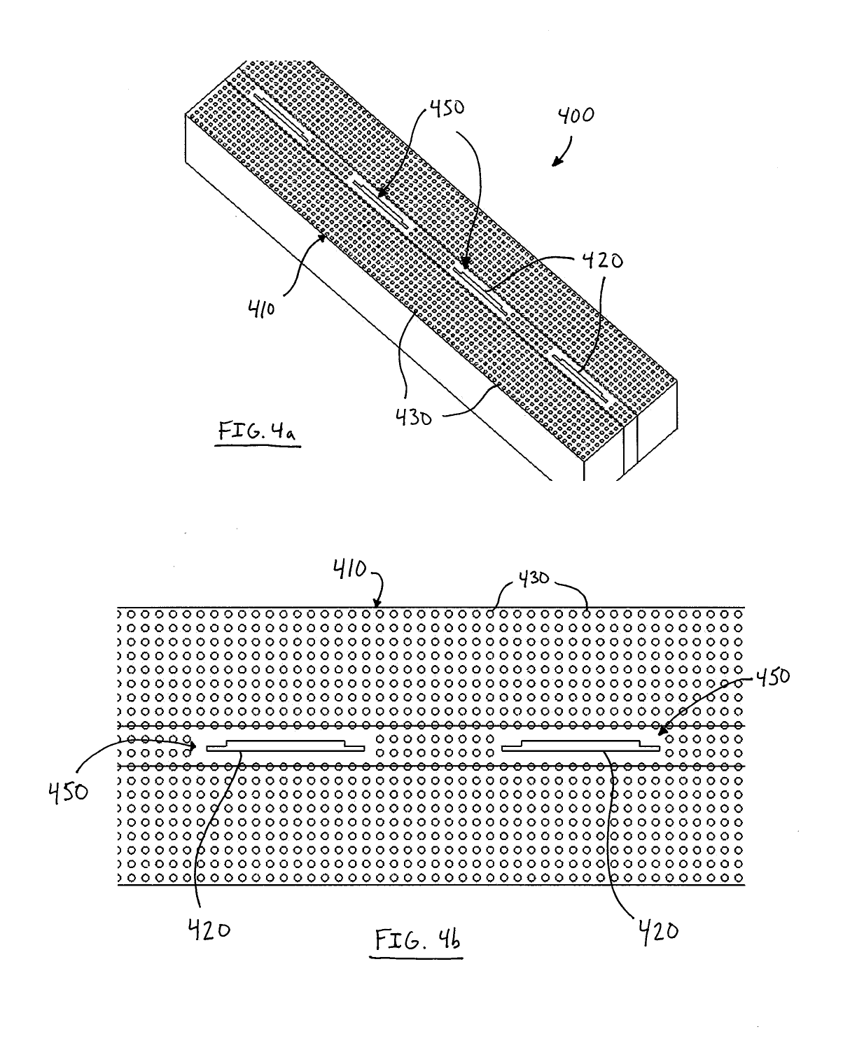

Referring specifically now to one example embodiment of the present disclosure illustrated in FIG. 3a, a head 300 may include a media bearing interface surface 310. The media bearing interface surface 310 may include one or more transducer elements 320, which can be configured to read or write the magnetic transitions from or onto magnetic media passing over the media bearing interface surface 310. Media bearing interface surface 310 may contain one or more surface texture modifications 330 or surface texture modification areas 335. These surface texture modifications may be positioned generally anywhere across the media bearing interface surface 310. However, in many embodiments, the surface texture modifications will not be positioned upon the read/write elements proper, which could degrade their performance. Some embodiments may depend on one or more of the desired characteristics of the media bearing interface surface 310, the characteristics and/or configuration of the head, the characteristics of the magnetic media being read or written to, the velocity of the magnetic media passing over the media interface surface, etc.

Surface modifications 330 may be any of a number of suitable surface modifications or textures, such as but not limited to dimples, recesses, circles, or any other designed feature or intrinsic process featured geometries or other means of decreasing the effective surface area of the head, including roughing up the surface by any suitable manner. In some embodiments, the surface modifications 330 can be designed as groupings of specific structures or may be simply regions where natural process exposure give the correct surface texture. For example, in some embodiments, ion impingement may be allowed to take place in an exposed region or in exposed regions which creates a natural texture based on the sputtering interaction with the exposed region(s) and the head slider body material. In still other embodiments, chemical etching or other material removal techniques can be employed in a designed manner so as to obtain specific micro-shapes, or to simply give a processed texture to a specific exposed region or exposed regions of the head slider body. In many embodiments, damage to the very small areal region of the read and write elements proper should be avoided with all such techniques so as to not degrade their performance.

In one embodiment, as shown in FIG. 3a, the media bearing interface surface may be separated into zones having surface modifications 330 and zones without surface modifications. As shown in FIGS. 3a and 3b, for example, the transducer elements 320 may be located in zones without surface modifications 330 while other areas of the head 300 between the transducer elements 320 may include surface modifications of a specified micro-geometry. FIG. 3b illustrates a further example embodiment of a media bearing interface surface 350 of the present disclosure having different surface modifications 360. The surface modifications 360 may differ in type, size, shape, pattern, etc. The surface modifications generally provide a relatively rougher texture to at least a portion of the media bearing surface interface. FIG. 3c illustrates a cross-sectional view of one type of example surface modifications, while FIG. 3d illustrates a cross-sectional view of another type of example surface modifications.

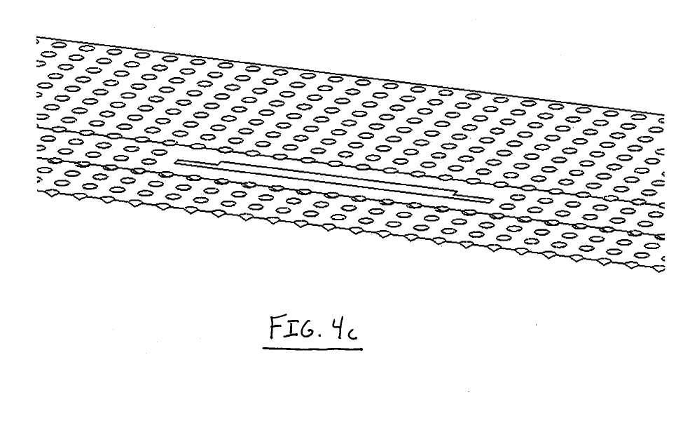

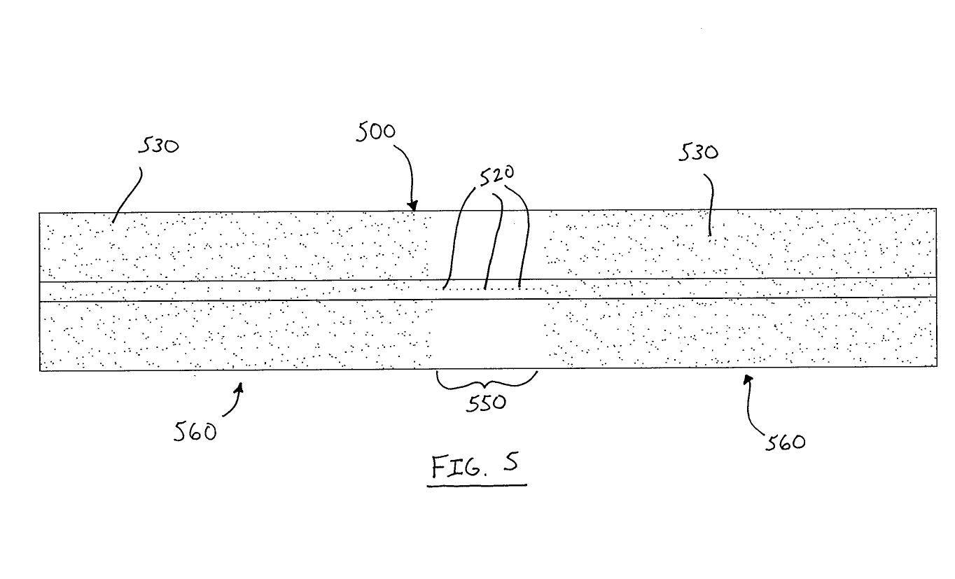

FIGS. 4a and 4b illustrate a further example embodiment of a head 400 and media bearing interface surface 410, wherein the transducer elements 420 are located in relatively smaller zones 450 without surface modifications, while the remaining portion of the media interface surface has been patterned with surface modifications 430. FIG. 4c illustrates a cross-sectional view of one type of example surface modifications for media bearing interface surface 410.

In yet another embodiment, illustrated in FIG. 5, the head or slider body may include a media bearing interface surface 500, which includes one or more transducer elements 520 located in a zone 550 that does not include surface modifications or surface texturing. This zone 550 may extend from one edge of the slider body or media bearing interface surface 500 to the opposite edge, leaving a zone near and encompassing all the transducer elements 520 without surface modifications. However, outside zone 550, the slider body 500 may include zones, such as zones 560, that have been patterned with surface modifications 530 or has been patterned with a surface texture. When providing surface modifications in such a manner, a large or substantial portion of the media bearing interface surface may be provided with surface modifications or surface texturing, while not degrading any performance of the transducer elements. In some embodiments, the media bearing interface surface 500 may be modified by placing capton tape, or ion milling tape, or other suitable guard or cover over the area of transducer elements 520. The remaining surface area of the media bearing interface surface 500 may be subjected to any thin film processing or other techniques, including but not limited to ion milling, laser ablation, etching, deposition, lithography or photolithography, etc. or any other suitable method of providing texture to the media bearing surface of the head, or any suitable combinations thereof. In some embodiments, such as with laser ablation, the capton tape may not be necessary, and a computer-aided control system may be used to guide the surface texturing.

However, the example embodiments shown in FIGS. 3-5 are illustrative in nature and are not limiting. In further embodiments, the location and density of the surface modifications may vary in a desired and/or designed manner over some or all of the media bearing interface surface of the head. For example, in some embodiments, the form of surface modifications can be designed shapes or regions of processed texture. In other embodiments, the form of the surface modifications may vary across the media bearing interface surface so as to allow for varying, or non-uniform friction, stiction and/or flying characteristics over the media bearing interface surface. In further embodiments, the particular form of surface modifications for each head can be chosen depending on the configuration needs of the head, such as but not limited to desired friction and stiction coefficients of the head-media interface, desired head-media spacing, desired dynamic flying characteristics, and start-stop characteristics.

The surface modifications may be formed in or onto the media bearing interface surface using any thin film processing or other techniques, including but not limited to ion milling, laser ablation, etching, deposition, lithography or photolithography, etc. or any other suitable method of providing texture to the media bearing surface of the head, or any suitable combinations thereof. In general, most embodiments will include the removal of slider material such that less surface area is exposed to the flexible recording medium. This removal process can be used to texture the exposed region(s) The exposed region(s) may have specific small-scale designs or patterns such as circle or hexagons or squares, or the exposed region(s) may have relatively large general areas of exposure. The surface modifications may be formed substantially simultaneously or the surface modifications or portions of the surface modifications may be formed in separate manufacturing steps, for example, when more than one type of surface modification is used. In several embodiments, the head slider will have zones of exposure to the texturing or surface modification, and the zones may be homogeneously textured or may contain sub-regions of designed patterns, each of which is textured or modified.

In general, by modifying the effective surface area of the media bearing interface surface, the friction and stiction coefficients of the head-media interface may be changed. In further embodiments, the location, geometry, and placement of the surface modifications may also work in conjunction with the head-media spacing and dynamic streaming characteristics to control the friction and stiction coefficients. For example, the surface modifications may comprise interface properties that are dependent on the velocity of the magnetic medium passing by the media bearing interface surface. However, in other embodiments, the surface modifications may comprise interface properties that are independent of the velocity of the magnetic medium passing by the media bearing interface surface. In further embodiments, where simply getting the tape media to start and stop without sticking to the head slider is an issue, the design emphasis can focus on eliminating that phenomenon while retaining good dynamic operational characteristics.

In operation, the various embodiments of heads of the present disclosure may be used to format flexible magnetic recording media or verify the formatting of flexible media, or may be used to write and read data from the flexible media. In the latter embodiment, the zone texture head slider could be used in the tape drive proper or tape drive system to write and read tape data cartridges and cassettes. In such embodiments, a tape drive system may include a head actuator assembly with read and write head sliders. The slider surfaces of the read and write head sliders may include media bearing interface surfaces with modifications as described herein.

To format flexible magnetic media, the magnetic media is passed, or flown, over the media bearing interface surface of a recording head of the present disclosure, and the transducers are energized to pattern the magnetic recording media with magnetic transitions. In some embodiments, the media may be patterned with amplitude-based patterns, while in other embodiments, the media may be patterned with timing-based patterns. In still further embodiments, the media may be patterned with a combination of amplitude-based and timing-based patterns, or any other suitable pattern or combination of patterns. The resulting recording media may have clearer magnetic transitions than recording media formatted using traditional recording heads because of the reduction of stiction and or friction between the magnetic media and the media interface surface of the recording head due to the presence of surface modifications. As clarity of these transitions increases, future generations of magnetic media may be able to hold an increased amount of data.

Although the various embodiments of the present disclosure have been described with reference to preferred embodiments, persons skilled in the art will recognize that changes may be made in form and detail without departing from the spirit and scope of the present disclosure.

We claim:

1. A magnetic recording head comprising a slider media bearing interface surface comprising surface modifications configured to reduce friction and/or stiction friction properties between the head slider media bearing interface surface and a recording medium.

2. The magnetic recording head of claim 1, wherein the slider media bearing interface surface comprises zones without the surface modifications and zones with the surface modifications.

3. The magnetic recording head of claim 2, wherein read/write elements are contained in zones without surface modifications.

4. The magnetic recording head of claim 2, wherein the zones with surface modifications comprise a relatively higher surface roughness than the zones without surface modifications.

5. The magnetic recording head of claim 2, wherein the surface modifications are non-uniform.

6. The magnetic recording head of claim 2, wherein the surface modifications are generally uniform.

7. The magnetic recording head of claim 2, wherein the surface modifications comprise designed geometric micro-regions that are recessed in the slider media bearing interface surface.

8. The magnetic recording head of claim 2, wherein the surface modifications comprise designed geometric micro-region structures which have surface texture modifications within their boundaries.

9. The magnetic recording head of claim 2, wherein the surface modifications are surface texture modifications.

10. A tape drive system comprising a head actuator assembly including a head slider body, the slider body comprising a slider media bearing interface surface comprising surface modifications configured to reduce friction and/or stiction friction properties between the slider media bearing interface surface and a recording medium.

11. The tape drive system of claim 10, wherein the slider media bearing interface surface comprises zones without the surface modifications and zones with the surface modifications.

12. The tape drive system of claim 11, wherein read/write elements are contained in zones without surface modifications.

13. The tape drive system of claim 11 wherein the zones with surface modifications comprise a relatively higher surface roughness than the zones without surface modifications.

14. The tape drive system of claim 11, wherein the surface modifications are non-uniform.

15. The tape drive system of claim 11, wherein the surface modifications are generally uniform.

16. The tape drive system of claim 11, wherein the surface modifications comprise designed geometric micro-regions that are recessed in the slider media bearing interface surface.

17. The tape drive system of claim 11, wherein the surface modifications comprise designed geometric micro-region structures which have surface texture modifications within their boundaries.

18. The tape drive system of claim 11, wherein the surface modifications are surface texture modifications.

19. A method of formatting magnetic tape comprising:
providing a magnetic recording head comprising a media bearing interface surface comprising surface modifications configured to reduce friction and/or stiction friction properties at an interface formed between the media bearing interface surface and a recordable medium; and
passing a recordable medium over the media bearing interface surface to record to the medium.

20. A magnetic recording media made by:
passing the magnetic recording media over a magnetic recording head comprising a media bearing interface surface comprising surface modifications configured to reduce friction and/or stiction friction properties at an interface formed between the media bearing interface surface and the magnetic recording media; and
energizing the magnetic recording head to cause a pattern of magnetic transitions to be written to the magnetic recording media.

21. The magnetic recording media of claim 19 wherein the pattern of magnetic transitions is a timing-based pattern.
